(19) United States
(12) Patent Application Publication
(10) Pub. No.: US 2006/0265596 A1
(43) Pub. Date: Nov. 23, 2006

(54) User authentication system, storage medium that stores a user authentication program, and service equipment

(75) Inventor: Tokimune Nagayama, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 10/908,575

(22) Filed: May 17, 2005

(51) Int. Cl. H04L 9/00

(52) U.S. Cl. 713/182

(57) ABSTRACT

A user authentication system serves to permit only specified users to use an image forming device, and includes a touch panel type display unit, and a control unit that performs authentication operations. The display unit is provided on the image forming device, and can input e-mail accounts. The control unit will permit the use of the image forming device by a user who has input an e-mail account, if the e-mail account input in the display unit matches any of a plurality of pre-registered e-mail accounts.

### BACKGROUND OF THE INVENTION

1. Field of the Invention

The present invention relates to a user authentication system, and more particularly to a user authentication system for allowing only specified users to use service equipment.

In addition, the present invention relates to a storage medium that stores a user authentication program that is executed by service equipment employed in the user authentication system.

Furthermore, the present invention relates to service equipment that is employed by the user authentication system.

2. Background Information

User authentication systems which allow the use of service equipment such as image forming devices and the like by only specified users continue to be introduced. This type of system is administered by a system administrator who charges fees to authenticated users who have obtained specific services.

An example of this type of conventional system is one in which an image forming device is connected to a management server in which identification data for normal users affiliated with a group is pre-registered, and a card reader is provided on the image forming device. The card reader serves to read identification data such as a group code and the like that is magnetically recorded on a card. Cards are distributed to users that are affiliated with a registered group.

In this system, when a card in the possession of a user is read by the card reader, the image forming device will contact the management server to determine whether or not the data read from the card matches the pre-registered data stored on the management server. If there is a match, the user will be allowed to use the image forming device.

However, with this type of system, if a user has forgotten to carry his or her card, the user's identity cannot be authenticated and thus the user cannot use the image forming device. Because of this, technology has been proposed in which authentication is performed by inputting a code for the group with which the user is affiliated, together with a password, into the image forming device instead of using a card (see, for example, Japanese Unexamined Patent Application Publication 2003-259045).

In the system disclosed in Japanese Unexamined Patent Application Publication 2003-259045, other persons cannot use a card to gain access to the image forming device without the permission of the card's owner. However, the group code can be leaked to outsiders or stolen, and thus there is a strong possibility that other persons will use the image forming device without proper authorization.

An object of the present invention is to devise a system that will more reliably authenticate the identity of a person attempting to use service equipment.

Another object of the present invention is to improve the utility and convenience of a user authentication system that can prevent the unauthorized use of different types of service equipment.

In view of the above, there exists a need for a user authentication system, storage medium that stores a user authentication program, and service equipment which overcome the above mentioned problems in the prior art. This invention addresses this need in the prior art as well as other needs, which will become apparent to those skilled in the art from this disclosure.

### SUMMARY OF THE INVENTION

A user authentication system according to a first aspect of the present invention serves to allow only specified users to use service equipment, and includes input means and authentication means. The input means is provided with the service equipment, and allows personal user data that belongs to a user to be input. If the personal user data input by means of the input means matches any of a plurality of pre-registered personal user data, the authentication means will allow the use of the service equipment by a user who has input the personal user data.

With this system, a person will be authenticated as a normal user and permitted to use service equipment only when that person inputs personal user data that matches pre-registered personal user data.

Identification data such as a group code and a password cannot be easily changed because that data is shared by a plurality of users in the same group. In contrast, if the personal user data is an e-mail account and a password, it will have a higher degree of identity with a user and can be changed at any time at the discretion of each user. Thus, the personal user data can be easily changed to thereby more reliably prevent the unauthorized use of service equipment, even in the rare instance that the personal user data is leaked, stolen, or the like.

Note that in the present invention, the term “personal user data” is defined to mean data that belongs to an individual user, e.g., an e-mail account, an account at an internet service provider, an account used when conducting business over the internet (such as internet shopping, internet auctions, ticket reservations, internet banking, etc.), or a combination of account data for an account other than the service that a user is attempting to use (e.g., member registration data for an internet service, etc.) and a password.

In addition, the term “service equipment” is defined to mean equipment that can provide specific services to a user, e.g., an image forming device that provides printing services and the like.

The user authentication system according to a second aspect of the present invention is the system of the first aspect, in which the personal user data includes an e-mail account that identifies a user.

More specifically, this system can be appropriately used by employing an e-mail account that has a high degree of identity with a user to perform authentication.

The system according to a third aspect of the present invention is the system of the second aspect, in which the service equipment is communicatively connected to a mail server in which a plurality of e-mail accounts are pre-registered. In addition, an authentication means is provided in the service equipment, which queries the mail server as to whether or not an e-mail account input by means of the input means matches any of the e-mail accounts registered in the mail server.

With this system, authentication queries and notification of authentication results are performed between the service equipment and the mail server by means of a communication protocol such as SMTP, POP, IMAP, and the like, and user authentication will be performed with the same process as the authentication operation performed when normal e-mail is sent and received. In addition, because the mail server is configured so as to perform authentication by means of the e-mail account of each user, it matches the system of the second aspect, which uses an e-mail account as data to be employed for authentication.

Furthermore, by using a mail server, there is no need to associate other data with each personal user data like in a database server, such as the services provided by the service equipment that can be used by a user. Thus, simply registering personal user data will be sufficient. Because of this, existing mail servers can be used without modification, and thus the burden of administering the service will be reduced.

The user authentication system according to a fourth aspect of the present invention is the system of the first aspect, and further includes data reading means that can read identification data from a data storage medium distributed to each user, and on which identification data is recorded which identifies the user. The input means can input personal user data in situations in which the user cannot supply the data reading means with the data recording medium.

With this system, authentication will normally be performed when a user supplies his or her data recording medium to the data reading means, and the data recording medium is read out thereby. In the event that a user is not carrying his or her data recording medium, the user can still use the service equipment by inputting his or her personal user data into the input means.

Note that examples of the data recording medium include, for example, a card having data magnetically recorded thereon that identifies a group that a user is affiliated with. Examples of the identification data include, for example, a group code. In addition, situations in which a user cannot supply the data recording medium to the data reading means include, for example, a situation in which a user is not carrying a card (an example of the data recording medium) and thus cannot insert the card in a card reader (an example of the data reading means) or the like.

The user authentication system according to a fifth aspect of the present invention is the system of the fourth aspect, in which the data storage medium is a group card on which is recorded data which identifies a group that a user is associated with. In addition, the data reading means is a card reader into which a group card can be inserted, and which can read identification data recorded on a group card inserted therein. Furthermore, the input means can input personal user data in the event that a group card is not inserted in the card reader.

Service equipment according to a sixth aspect of the present invention comprises input means and authentication means. The input means can input personal user data that belongs to a user. In the event that personal user data input by the input means matches any of a plurality of pre-registered personal user data, the authentication means will allow the use of the service equipment by a user who has input the personal user data.

A storage medium according to a seventh aspect of the present invention stores a user authentication program that is executed by service equipment in a user authentication system which serves to permit the use of the service equipment by only specified users. The user authentication program executes an input reception step and an authentication step in the service equipment. The input reception step can receive personal user data that belongs to the user and that has been input into the service equipment. In the event that personal user data input in the input step matches any of a plurality of pre-registered personal user data, the authentication step will allow the use of service equipment by a user who has input the personal user data.

When this program is executed, and the personal user data received from a user who is attempting to use the service equipment matches the pre-registered personal user data, the user will be permitted to use the service equipment as an authorized user.

The personal user data has a high degree of identity with a user, and can be easily changed at the discretion of each user. Thus, even if the personal user data is leaked, stolen, or the like, unauthorized use by another person can be prevented by changing the password at any time.

The user authentication system according to an eighth aspect of the present invention comprises service equipment, a first authentication unit, and a second authentication unit. The service equipment provides specified services to users, and has input means that can input personal user data. The first authentication unit is communicatively connected to the service equipment, stores a plurality of personal user data, and performs authentication by determining whether or not input personal user data matches any of the plurality of personal user data. The second authentication unit is communicatively connected to the first authentication unit, and stores a plurality of personal user data that has been pre-registered as persons who can use the service equipment. When authentication by the first authentication is successful and the address of the second authentication unit is stored in the service equipment, the second authentication unit will perform authentication by determining whether or not the personal user data input in the input means matches any of the plurality of pre-registered personal user data. If the authentication by the second authentication unit is successful, use of the service equipment by the user who input the personal user data will be permitted.

With the system according to the second aspect described above, a plurality of e-mail accounts and passwords of users that can use an image forming device (service equipment) are pre-registered, authentication is performed by comparing whether or not the e-mail account and the like input into the image forming device by a user matches any of the pre-registered e-mail accounts and the like, and use of the image forming device will be permitted by that user if authentication was successful. However, with this type of system, it is necessary for the e-mail account of a user who desires to use the image forming device to be pre-registered therein, and thus the usability of the image forming device is limited, and the usability and convenience of the system is lacking.

Accordingly, with the system according to the eighth aspect, when the address of the second authentication unit is stored in the service equipment, and a user who attempts to use the service equipment inputs personal user data therein, authentication will be first performed by the first authentication unit, and if authentication was successful, then authentication will be performed by the second authentication unit, and the user who input the personal user data will be able to use the service equipment.

Thus, there is no need for a person who can use service equipment to be registered in the service equipment, and may instead be registered in the second authentication unit. In other words, with this system, if a user registers their own personal user data in the second authentication unit, that user can use service equipment spread over a wide area regardless of whether or not the user's personal user data is registered in the service equipment, and thus the utility and convenience of the system will improve.

In addition, in the event that the final authorization as to whether or not a user can use the service equipment is performed by the second authorization unit, personal user data may be stored in the first authorization unit. Thus, in this situation, the first authentication unit may, for example, be a mail server or the like that stores an unspecified large number of personal user data and administered by an internet service provider.

On the other hand, with this system, in the event that the address of the second authentication unit is not stored in the service equipment, authentication can be performed without the second authentication unit by registering users that can use the service equipment in the first authentication unit. For example, in the event that group administration is performed in an organization such as a company or the like, just a mail server can be used inside the company to perform user authentication.

Note also that examples of the second authentication unit include, for example, a fee host that can charge a fee to a user that has used the service equipment.

The user authentication system according to a ninth aspect of the present invention is the system of the eighth aspect, in which a plurality of first authentication units are provided, and each first authentication unit has a unique address. In addition, the addresses of the first authentication units can be input in the input means of the service equipment. The service equipment will transmit the personal user data to an address of a first authentication unit that was input by the input means.

With this system, the convenience and the utility thereof will improve because a user can freely designate the first authentication unit that is good for authenticating the use of service equipment.

Note also that examples of the address include an IP address or any other indicator that indicates a location on a network. In addition, a specific example of a first authentication unit that is good for authentication is a server that can access the second authentication unit in which the user is registered as one who can use the service equipment, e.g., a server or the like that is designated by means of a contract for use of the service equipment.

The user authentication system according a tenth aspect of the present invention is the system of the eighth aspect, in which the service equipment stores the address of the second authentication unit. In addition, the first authentication unit is a mail server in the possession of an internet service provider that a user is associated with.

With the system of the present invention, if a user's e-mail address is used as the personal user data and a mail server is used as the first authentication unit, authentication can be performed in the same way as that performed during the transmission and receipt of normal e-mail. However, in the event that a mail server is used in which an extremely large number of users are registered, such as a mail server possessed by an internet service provider, there is a possibility that authentication will be performed all at once by nearly all of the users, and that leaks may occur during fee processing.

Accordingly, in the system according to the tenth aspect, even if this situation occurs, leakage of fee information will be prevented, and a more suitable operation will be made possible, by performing the final authentication by means of both the first authentication unit and the second authentication unit.

The user authentication system according to an eleventh aspect of the present invention is the system of the eighth aspect, in which the second authentication unit is a fee host that manages use of the service equipment, and charges fees to users that have used the service equipment.

With this system, a series of operations can be efficiently performed from authentication to the charging of a fee, by having the fee host both charge a fee to a user that has actually obtained a service and play the role of the second authentication unit.

The service equipment according to a twelfth aspect of the present invention includes input means, output signal production means, and communication means. The input means can input the personal user data. The output signal producing means produces output signals for transmitting personal user data input by means of the input means. The output signals are produced for a first authentication unit and a second authentication unit. The first authentication unit stores a plurality of personal user data and will perform authentication by determining whether or not the personal user data input matches any of the plurality of personal user data. The second authentication unit stores a plurality of personal user data that was pre-registered as persons who can receive specified services. In the event that authentication by the first authentication is successful and the address of the second authentication unit is stored in the service equipment, the second authentication unit will perform authentication by determining whether or not the personal user data input in the input means matches any of the plurality of pre-registered personal user data, and the second authentication unit will permit the use of the service equipment by the user who input the personal user data when the authentication was successful. The communication unit transmits the output signals to the first and second authentication units, and can receive output signals regarding authentication results from the first and second authentication units.

With this equipment, when personal user data is input by the input means, an output signal is produced in order to request authentication from two authentication units based upon the personal user data, the output signal produced is sent from the communication unit to the two authentication units, and authentication is performed based upon the personal user data sent to each authentication unit.

A storage medium according to a thirteenth aspect of the present invention stores a user authentication program that is executed by service equipment in a user authentication system which serves to permit the use of the service equipment by specified users. The user authentication program executes an input reception step, an output signal production step, and a communication step in the service equipment. The input reception step receives input of personal user data. The output signal producing step produces output signals for transmitting personal user data input by means of the input means. The output signals are produced for a first authentication unit and a second authentication unit. The first authentication unit stores a plurality of personal user data and will perform authentication by determining whether or not the personal user data input matches any of the plurality of personal user data. The second authentication unit stores a plurality of personal user data that was pre-registered as persons who can receive specified services. In the event that authentication by the first authentication is successful and the address of the second authentication unit is stored in the service equipment, the second authentication unit will perform authentication by determining whether or not the personal user data input in the input means matches any of the plurality of pre-registered personal user data, and the second authentication unit will permit the use of the service equipment by the user who input the personal user data when the authentication was successful. The communication step transmits the output signals to the first and second authentication units, and receives output signals regarding authentication results from the first and second authentication units.

Thus, with the user authentication system that uses this equipment, effects that are identical with those of the system according to the first aspect can be obtained.

According to the present invention, although personal user data such as an e-mail account can be used to perform authentication, because the personal user data has a high degree of identity with a user and can be easily changed at the discretion of each user, unauthorized use by others can be prevented by freely changing the password, even if the personal user data is leaked, stolen, or the like.

In addition, according to the present invention, there is no need for a person who can use service equipment to be registered in the service equipment, and may instead be registered in the second authentication unit. In other words, with this system, if a user registers their own personal user data in the second authentication unit, that user can use service equipment spread over a wide area regardless of whether or not the user's personal user data is registered in the service equipment, and thus the utility and convenience of the system will improve.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 shows a block diagram of a user authentication system in which a first embodiment of the present invention is adopted;

FIG. 2 shows an operation screen that is displayed on a display unit of an image forming device of the system of the first embodiment;

FIG. 3 shows an operation screen that is displayed on a display unit of an image forming device of the system of the first embodiment;

FIG. 4 shows a user authentication program that is executed by the system of the first embodiment;

FIG. 5 shows a flow chart for describing the operation of the system of the first embodiment;

FIG. 6 shows a block diagram of a user authentication system in which a second embodiment of the present invention is adopted;

FIG. 7 shows an operation screen that is displayed on a display unit of an image forming device of the system of the second embodiment;

FIG. 8 shows another operation screen that is displayed on a display unit of an image forming device of the system of the second embodiment;

FIG. 9 shows a fee request e-mail that is transmitted to a fee host from an image forming device of the system of the second embodiment; and

FIG. 10 shows a flow chart for describing the operation of the user authentication system of the second embodiment.

### DETAILED DESCRIPTION OF THE PREFERRED EMBODIMENTS

### First Embodiment

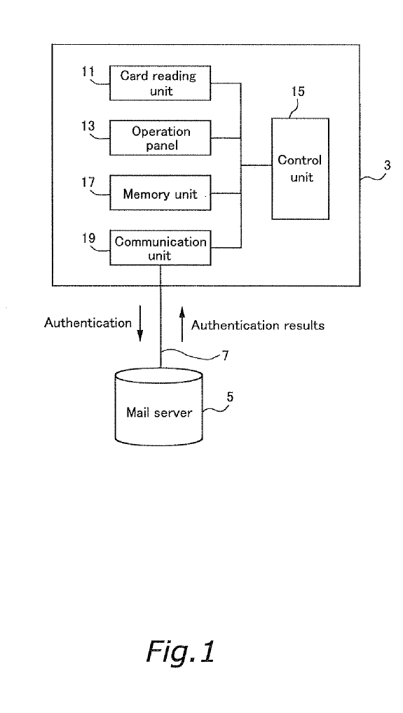

FIG. 1 shows a user authentication system in which a first embodiment of the present invention is adopted.

The user authentication system 1 serves to permit the use of an image forming device (service equipment) 3 by only specific users, and includes an image forming device 3 and a mail server 5. The image forming device 3 and mail server 5 are connected via a communication line 7.

In this embodiment, the term “specific users” is defined to mean users associated with a group who have been granted rights to use the image forming device 3, and more particularly, the registered e-mail accounts of users who are authorized to use a “Scan to E-mail” function of the image forming device 3 to transmit an image of a document by e-mail. The “Scan to E-Mail” function converts image data read by means of an image reading unit (described below) to PDF, JPEG, TIFF, or other formats and then transmits this as an e-mail.

Image Forming Device

The image forming device 3 is located in an organization such as a company, a university, or the like which is made up of a plurality of groups. The image forming device 3 includes a card reading unit (data reading means) 11, an operation panel 13, a control unit 15, a memory unit 17, and a communication unit 19.

The card reading unit 111 reads a group code magnetically stored in a group card (not shown in the figures) that is distributed to users affiliated with each group, and serves to permit the use of the image forming device 3 by authorized users. The card reading unit 11 includes a commercially available card reader, and an insertion slot (not shown in the figures) for inserting a group card. When a user inserts a group card into the insertion slot, the group code registered on the card will be read out, card authentication will be performed, and the image forming device 3 will be made available for use.

The operation panel 13 has a plurality of operation keys (not shown in the figures) and a display unit 21. The operation keys include a start key used to commence printing, and a key that displays an operation screen on the display unit 21 which is used for group administration. The display unit 21 includes a touch panel type liquid crystal display, and will display an operation screen for setting print parameters, and the operation screen for group administration. The group administration screen allows a user to select any group from amongst a plurality of groups, and to tabulate the number of pages output for the group selected.

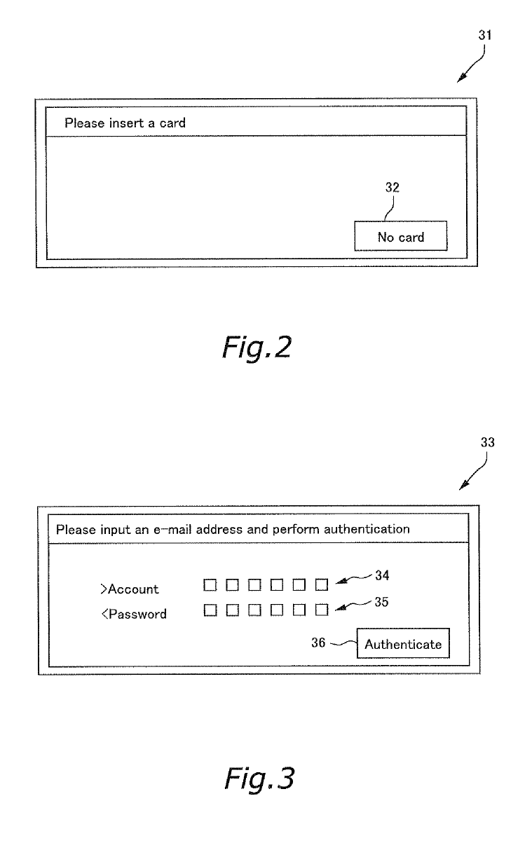

In addition, the operation screens 31, 33 shown in FIGS. 2 and 3 can also be displayed on the display unit 21. The operation screen 31 serves to prompt a user to insert a group card. The operation screen 31 has a “no card” button 32, which can be used to perform user authentication (described below) rather than card authentication. This button will be pushed in situations in which a group card cannot be inserted into the card reading unit 11 because, for example, a user is not carrying his or her group card.

The operation screen 33 serves to input data needed for user authentication, and is displayed when a user pushes the “no card” button 32 on the operation screen 31. The operation screen 33 has an account input section 34, a password input section 35, and an authentication button 36 for requesting permission to use the image forming device 3. When a user inputs his or her e-mail account and password into sections 34, 35 of the operation screen 33 and then pushes the authentication button 36, authentication will be performed in the image forming device 3 as well as via the mail server 5.

The control unit 15 includes a CPU that is connected to I/O units such as the card reading unit 11 and the operation panel 13, and will not only control the operation of these I/O units, but can also execute a user authentication program (described below) to perform user authentication.

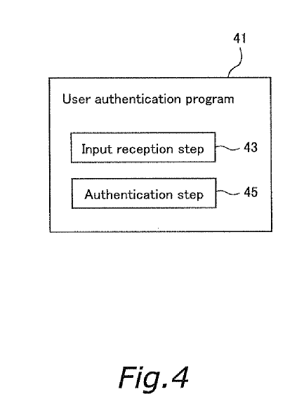

The memory unit 17 includes memory that is connected to the CPU, and in addition to storing a control program for the I/O units, also stores a group administration program for group administration, a card authentication program which uses group cards, and a user authentication program 41 (see FIG. 4) which does not use group cards. A program related to the “Scan to E-mail” function is included in the control program. The group administration program and the card authentication program are identical to commercially available versions thereof.

The user authentication program 41 is configured so that both an input acceptance step 43 and an authentication step 45 are executed by the control unit 15. The input acceptance step 43 is executed when the “no card” button 32 of the operation screen 31 is pushed, the operation screen 33 is displayed on the display unit 21, and an e-mail account and password input by a user is received.

The authentication step 45 is executed when the authentication button 36 of the operation screen 33 is pushed, and will first determine whether or not the user has been previously registered as an authorized user of the “Scan to E-mail” function in the image forming device 3. Then, if the sender is registered in the image forming device 3 as such, this data will be sent to the mail server 5 in order to query whether or not the sender is registered in the mail server 5. If the mail server 5 also responds that the sender is registered, use of the image forming device 3 by the user will be permitted, and a message indicating this (e.g., “Copying can now be performed”) will be displayed on the display unit 21. On the other hand, in situations in which the mail server 5 responds that the data is not registered, or in situations in which the user is not registered in the image forming device 3 as a user of the “Scan to E-mail” function, a message indicating this (e.g., “Could not authenticate”) will be displayed on the display unit 21.

In addition, the group code for each group is stored in the memory unit 17, as well as the e-mail accounts of the users affiliated with each group and the passwords for each e-mail address. Furthermore, users that are permitted to use the image forming device 3 are registered as authorized users of the “Scan to E-mail” function in the memory unit 17.

The communication unit 19 serves to transmit signals from the control unit 15 to the mail server 5, and receive signals from the mail server 5. The communication unit 19 has a network card that is connected to the communication line 7, and is set to whatever server is to be queried for authentication (here, mail server 5).

In addition, the image forming device 3 further includes other I/O units such as an image reading unit that serves to read image data from an original document, and an image forming unit that serves to perform image formation based upon image data read by the image reading unit or image data transmitted from the outside.

Mail Server

The mail server 5 is a computer that forms an electronic mail system, and has, among other things, a message transmission/reception function, a mail box function, and a message administration function. The mail server 5 is administered by a third person located outside the organization containing the group in which the image forming device 3 is located.

Operation of the User Authentication System

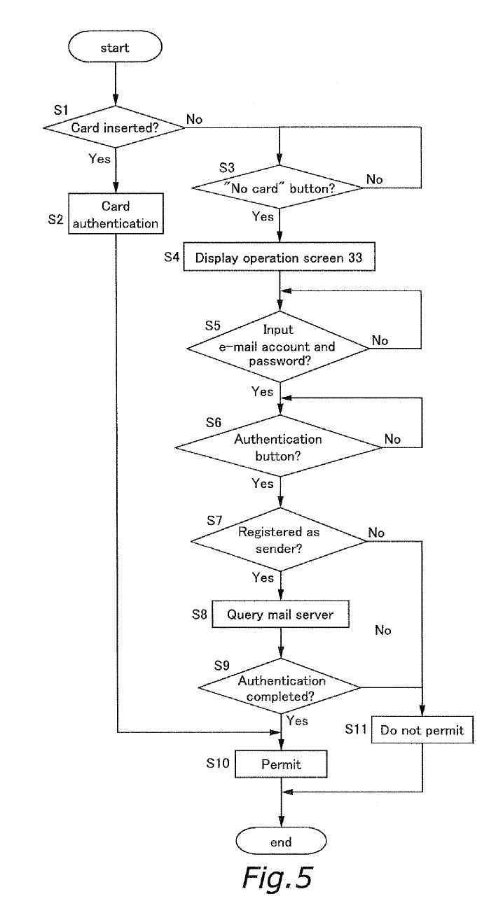

The operation of the user authentication system 1 will be described with reference to FIG. 5.

When a group card is inserted into the card reading unit 11 by a user who is attempting to use the image forming device 3 (S1), card authentication is performed by the group code recorded on the card (S2), and the use of the image forming device 3 is permitted (S10).

On the other hand, if a user cannot insert a group card into the card reading unit 111 because he or she is not carrying it (S1), the “no card” button 32 of the operation screen 31 displayed on the display unit 21 of the image forming device 3 will be pushed by that user (S3), and thereby display the operation screen 33 (S4). Then, if the user inputs his or her e-mail account and password in the operation screen 33 (S5) and pushes the authentication button 36 (S6), an authentication operation will be performed in the image forming device 3. It is then determined whether or not the e-mail account input has been registered in the image forming device 3 as an authorized user of the “Scan to E-mail” function (S7), and if it is registered, the mail server 5 is queried as to whether or not the e-mail account and password input in Step S5 is registered (S8). Then, if the response indicates that registration has been performed and that authentication is successful (S9), use of the image forming device 3 will be permitted (S10), and this fact will be displayed on the display unit 21.

On the other hand, if the response from the mail server 5 indicates that the e-mail account and password are not registered, or if the response indicates that the e-mail account has not been registered as an authorized user of the “Scan to E-mail” function in Step S7, then it is determined that authorization was unsuccessful (S9), permission to use the image formation device 3 will not be granted to the user (S11), and a message to this effect will be displayed on the display unit 21.

If the image forming device 3 is used via this type of authorization operation, the number of pages output to the memory unit 17 will be saved, and when group administration is performed by a system administrator, the number of pages output by a specific group at a given point in time will be displayed on the display unit, and a fee can be charged to that group as needed. Note also that after tabulation has been performed or a fee has been charged, the number of pages output by a group will be cleared and counting will begin again.

According to the user authentication system 1 described above, even in situations in which card authentication cannot be performed because a user is not carrying a group card, the e-mail account or the like of that user can be input, used to perform user authentication, and thus permit the use of the image forming device 3.

Because authorization is performed by means of an e-mail account or the like that has a high degree of identity with a user, unauthorized use by others can be prevented by changing the password at any time at the discretion of each user, even when the password is leaked, stolen, or the like.

In addition, with the user authorization system 1, authorization can also be performed in the image forming device 3 by using the registered e-mail accounts of authorized users of the “Scan to E-mail” function of the image forming device 3, and thus the unauthorized use by others of the image forming device 3 can be more reliably prevented.

Note also that in the first embodiment, if authentication is to be performed by means of an e-mail account and password input into the image forming device 3, then another server may be used in order to query for personal user data instead of the mail server 5. In addition, this server may for example be an administration server that is located inside a company, university, or other organization and administered by that organization, or may be an administration server that is located outside the organization but administered by the organization.

Moreover, in the aforementioned user authentication system, in the event that the image forming device 3 is communicatively connected with an administrator but authentication could not be performed in the mail server 5, or in the event that the operation screen 33 is displayed again and the input of an e-mail account or the like is requested but authentication could not be performed within a predetermined number of attempts, the administrator can be informed of this fact.

Furthermore, the user authentication system of the present invention can also be applied to service equipment that performs, in normal situations, authentication with means other than a card.

### Second Embodiment

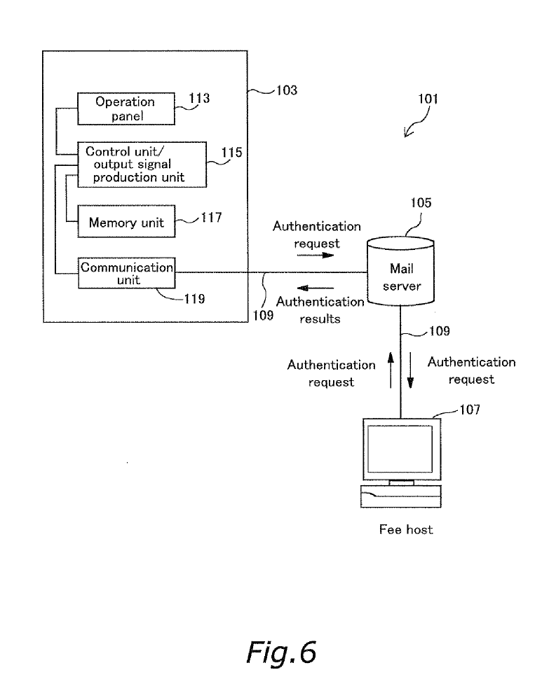

FIG. 6 shows a user authentication system 101 in which a second embodiment of the present invention is adopted.

This system 101 serves to permit specific users to use an image forming device 103, and includes the image forming device (service equipment) 103, a mail server (first authentication unit) 105, and a fee host (second authentication unit) 107. The image forming device 103, the mail server 105, and the fee host 107 are connected together via a communication line 109.

Image Forming Device

The image forming device 103 includes an operation panel 113, a control unit 115, a memory unit 117, and a communication unit 119.

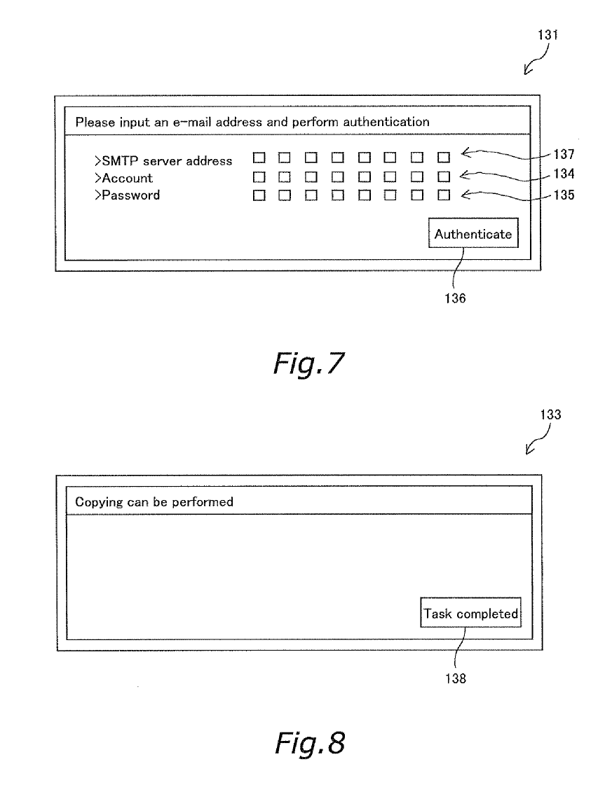

The operation panel 113 has a plurality of operation keys and a display unit (not shown in the figures). The operation keys include a start key used to commence printing, and a ten key for input into the operation screen 131 (described below). The display unit includes a touch panel type liquid crystal display, and will display, among other things, an operation screen for setting print parameters, and the operation screens 131, 133 shown in FIGS. 7 and 8. The operation screen 131 serves to input data needed for user authentication. The operation screen 131 has a server address input section 137, an account input section 134, and a password input section 135, as well as an authentication button 136 for requesting authentication from the mail server 105 and the fee host 107. When a user inputs data into the sections 137, 134, and 135 and pushes the authentication button 136, an output signal will be produced in the control unit 115 for authentication and will then be transmitted to the mail server 105 or the like (described below). The operation screen 133 will be displayed while standing by for printing (as well as after a user has completed his or her printing), and includes a “task completed” button 138 that serves to notify the fee host 107 that a task has been completed. Note also that the operation screen 133 not only displays the “task completed” button 138, but may also display another button for setting print parameters.

The control unit 115 includes a CPU connected to the I/O units of the operation panel 113, the communication unit 119, and the like, and both controls the operation of these I/O units and controls the user authentication operation. The control unit 115 can switch between a fee request mode that requests a fee from a user who has used the image forming device 103, and a normal mode that does not perform this type of fee request, by means of a predetermined operation on the operation panel 113.

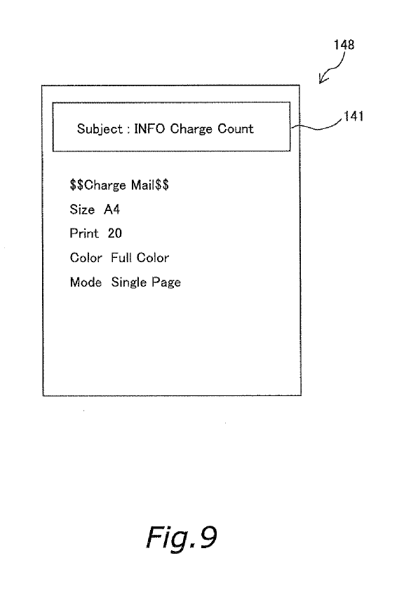

When the fee request mode has been set, the control unit 115 will display the operation screen 131 on the display unit if a user attempts to use the image forming device 103 by touching the display unit or pushing an operation key. In addition, if the authentication button 136 of the operation screen 131 is pushed, the control unit 115 will produce an output signal for requesting authentication from the mail server 105 (the output signal production unit), and will transmit this output signal to the mail server 105 and the like via the communication unit 119. Furthermore, the control unit 115 will request authentication by receiving the results of the authentication from the mail server 105 and then transmit a registration data e-mail to the fee host 107, as well as transmit a fee data e-mail 148 (like that shown in FIG. 9) thereto when a user's printing tasks have been completed.

The registration data e-mail serves to query the fee host 107 as to whether or not a user is registered, and includes the e-mail account and password input by the user. The registration data e-mail is transmitted to the fee host 107 via the e-mail server 105. In addition, the fee data e-mail serves to alert the fee host 107 that a user has used the image forming device 103, and like the registration data e-mail, is sent to the fee host 107 via the mail server 105. The fee request e-mail uses predetermined software (described below) stored in the memory unit 117 to display the specific details of the service received by the user, such as the paper size, the number of pages printed, whether or not color printing was performed, and the like, and as shown in FIG. 9, includes an e-mail subject section 141. A command which is to be executed in the fee host 107 is set, as described below, to be the subject displayed in the subject box 141.

The memory unit 117 includes memory that is connected to the CPU, and not only stores a control program for the I/O units, but also stores a user authentication program which serves to authenticate a user, and predetermined software for producing and transmitting the fee data e-mail. In addition, the IP addresses of the mail server 105 and the fee host 107 are stored in the memory unit 117. Note also that the IP address of the fee host 107 is also the address to which the fee data e-mail 148 will be transmitted. In addition, the IP address of the fee host 107 will, for example, be input by a service representative when the image forming device 103 is first installed in an organization.

The communication unit 119 includes a network card or the like that is connected to the communication line 109, and performs tasks such as transmitting output signals for authentication, and receiving signals related to the authentication results from the mail server 105 and the like.

In addition, the image forming device 103 further includes other I/O units, such as an image reading unit for reading image data from an original document, and an image forming unit for performing image formation based upon image data read by the image reading unit and image data transmitted from the outside.

Mail Server

The mail server 105 is a SMTP (Simple Mail Transfer Protocol) server computer that forms an electronic mail system, and here, is administered by an internet service provider. The mail server 105 has a memory unit, and stores in the memory unit the e-mail accounts and passwords of a plurality of users (both individuals and groups) that have contracted for an internet connection with the internet service provider.

When the mail server 105 receives from the image forming device 103 an output signal that requests authentication, the mail server 105 will verify whether or not any of the plurality of e-mail accounts and passwords match the e-mail account and password input in the image forming device 103, and will transmit the result to the image forming device 103 as an authentication result. Then, when this authentication result is received and a registration confirmation e-mail is transmitted from the image forming device 103, the mail server 105 will function as an intermediary between the image forming device 103 and the fee host 107.

Fee Host

The fee host 107 is a host computer, and is owned by an administration center which manages the usage of the image forming device 103 and charges fees. The fee host 107 has a memory unit that includes a database, and this database stores a plurality of user e-mail accounts and passwords that have been registered as users who can use the image forming device 103.

When the fee host 107 receives a registration confirmation e-mail from the image forming device 103, the fee host 107 will verify whether or not the e-mail account and password of the user that is contained in the registration confirmation e-mail matches any of the plurality of e-mail accounts and passwords pre-registered in the database, and will send the result to the image forming device 103 as an authentication result.

In addition, when the fee host 107 receives a fee data e-mail from the image forming device 103, an invoice will be produced and transmitted by e-mail to the user. Predetermined software that automatically receives and processes fee data e-mails from the image forming device 103 is installed in the fee host 107. When the fee host 107 receives a fee data e-mail, it will calculate the price of the service obtained by a user, and will produce an invoice based upon the calculated amount.

Operation of the User Authentication System

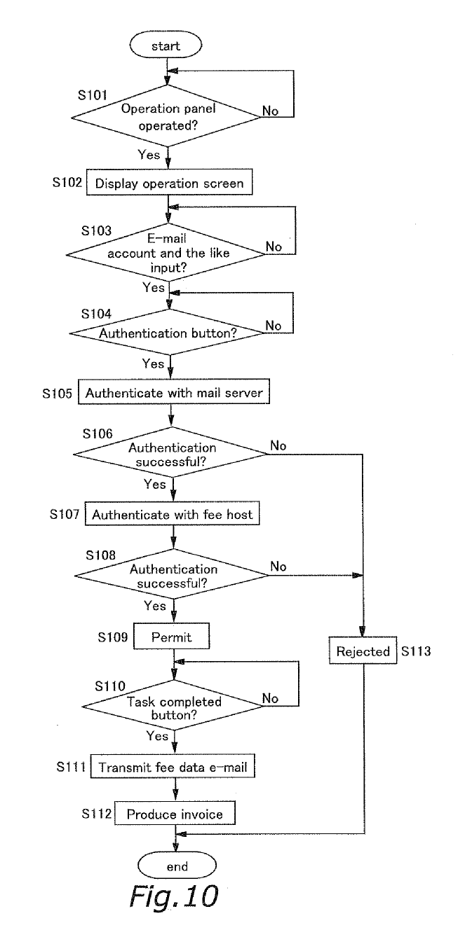

The operation of the user authentication system 101 will now be described with reference to FIG. 10.

Note that it is assumed here that the image forming device 103 has been set to the fee request mode.

On the image forming device 103 side, when a user touches or otherwise operates the operation panel 113 (S101), the operation screen 131 will be displayed on the display unit (S102), the user will input his or her e-mail account or the like in the operation screen 131 (S103), and when the user pushes the authentication button 136 (S104), authentication will be requested to the mail server 105 (S105). Then, if authentication in the mail server 105 was successful (S106), a registration authentication e-mail will be sent from the image forming device 103 to the fee host 107 and authentication will be requested (S107). If authentication was successful in the fee host 107 as well (S108), use of the image forming device by the user will be permitted (S109).

When the user has finished using the image forming device 103, the operation screen 133 will be displayed on the display panel, and the “task completed” button will be pushed (S110). When this occurs, a fee data e-mail will be sent from the image forming device 103 to the fee host 107 (S111), and the fee host 107 will automatically tabulate the number of pages printed and the like and prepare an invoice (S112).

On the other hand, if authorization was unsuccessful in Steps S106 or S108, use of the image forming device 103 will not be permitted (S113).

According to the aforementioned user authentication system 101, there will be no need for a user who attempts to use the image forming device 103 to be registered in the image forming device 103 if the user is registered in the fee host 107. In other words, if the e-mail address and the password of a user are registered in the fee host 107, the user can be authorized to use the image forming device 103 even if his or her e-mail account and the like are not registered in the image forming device 103.

Thus, for example, when a user is to use an image forming device that can be used by a large number of unspecified users, such as in the case of a copy machine located in a convenience store, that user can use the copy machine even though his or her e-mail account and the like is not registered therein. This will improve the usability and convenience of the system.

In addition, if a user is a registered user of an image forming device, the user can conveniently use an e-mail address that he or she normally uses, and does not need to memorize other account data or the like.

Note also that in the second embodiment, if the aforementioned predetermined software is not installed as the client that receives the fee data e-mail, the fee host may be configured to receive the fee data e-mail as a normal mail client.

In addition, in the second embodiment, if the IP address of the fee host is not stored in the image forming device, authentication may only be performed in the mail server (the first authentication unit). For example, when group administration is to be performed in one organization such as a company or a university, persons who can use an image forming device may be registered in the mail server, and authentication and the charging of fees can be performed therein.

Furthermore, a plurality of computers that include the aforementioned mail server may be used as the first authentication unit.

In addition, the first authentication unit is not limited to a mail server, and may be another type of computer.

Note also that in the system of the present invention, the service equipment is not limited to an image forming device, and may be another type of service equipment.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A user authentication system which serves to permit only specified users to use service equipment, comprising:
input means provided on the service equipment which allows personal user data that belongs to a user to be input into the service equipment; and
authentication means that permits the use of the service equipment by a user who has input personal user data by means of the input means, when the personal user data matches any of a plurality of pre-registered personal user data.

2. The user authentication system according to claim 1, wherein the personal user data includes an e-mail account that belongs to the user.

3. The user authentication system according to claim 2, wherein the service equipment is communicatively connected to a mail server in which a plurality of e-mail accounts are pre-registered, and
the authentication means is provided in the service equipment, and queries the mail server as to whether or not an e-mail account input by means of the input means matches any of the e-mail accounts registered in the mail server.

4. The user authentication system according to claim 1, further comprising data reading means that can read identification data from a data storage medium distributed to each user and on which identification data is recorded which identifies a user;
wherein the input means can input personal user data in the event that the user cannot supply the data storage medium to the data reading means.

5. The user authentication system according to claim 4, wherein the data storage medium is a group card which stores identification data of a group that a user is associated with;
the data reading means is a card reader in which the group card can be inserted, and which can read the identification data recorded on the group card inserted therein; and
the input means can input personal user data in the event that the group card is not inserted in the card reader.

6. Service equipment, comprising:
input means that can input personal user data that belongs to a user; and
authentication means that will permit the use of the service equipment by a user who has input personal user data by means of the input means when the personal user data matches any of a plurality of pre-registered personal user data.

7. A storage medium comprising a user authentication program that is executed by service equipment in a user authentication system which serves to permit the use of the service equipment by only specified users;
wherein the user authentication program executes in the service equipment,
an input reception step which can receive personal user data belonging to a user that has been input into the service equipment; and
an authentication step that will permit the use of the service equipment by a user who has input the personal user data, when the personal user data input in the input reception step matches any of a plurality of pre-registered personal user data.

8. A user authentication system, comprising:
service equipment that provides specified services to a user and which has input means that can input personal user data;
a first authentication unit that is communicatively connected to the service equipment, stores a plurality of personal user data, and performs authentication by determining whether or not input personal user data matches any of the plurality of personal user data; and
a second authentication unit that is communicatively connected to the first authentication unit, and stores a plurality of personal user data that has been pre-registered as persons who can use the service equipment;
wherein when authentication by the first authentication unit is successful and the address of the second authentication unit is stored in the service equipment, the second authentication unit will perform authentication by determining whether or not the personal user data input in the input means matches any of the plurality of pre-registered personal user data, and when authentication by the second authentication unit is successful, use of the service equipment by the user who input the personal user data will be permitted.

9. The user authentication system according to claim 8, wherein a plurality of first authentication units are provided, and each first authentication unit has a unique address;
the addresses of the first authentication units can be further input in the input means of the service equipment; and
the service equipment will transmit personal user data to an address of first authentication unit that was input in the input means.

10. The user authentication system of claim 8, wherein the service equipment stores the address of the second authentication unit; and
the first authentication unit is a mail server in the possession of an internet service provider that a user is associated with.

11. The user authentication system according to claim 8, wherein the second authentication unit is a fee host that manages use of the service equipment, and charges a fee to a user that has used the service equipment.

12. Service equipment, comprising:
input means that can input personal user data;
output signal producing means that produces output signals for transmitting personal user data input by means of the input means, the output signals produced for a first authentication unit that stores a plurality of personal user data and which will perform authentication by determining whether or not the personal user data input matches any of the plurality of personal user data, and a second authentication unit that stores a plurality of personal user data that was pre-registered as persons who can receive specified services; and
a communication unit that transmits the output signals to the first and second authentication units, and can receive output signals regarding authentication results from the first and second authentication units;
wherein when authentication by the first authentication is successful and the address of the second authentication unit is stored in the service equipment, the second authentication unit will perform authentication by determining whether or not the personal user data input in the input means matches any of the plurality of pre-registered personal user data, and the second authentication unit will permit the use of the service equipment by the user who input the personal user data when the authentication was successful.

13. A storage medium comprising a user authentication program that is executed by service equipment in a user authentication system which serves to permit the use of the service equipment by specified users;
wherein the user authentication program executes in the service equipment,
an input reception step that receives input of personal user data;
an output signal producing step that produces output signals for transmitting personal user data input by means of the input means, the output signals produced for a first authentication unit that stores a plurality of personal user data and which will perform authentication by determining whether or not the personal user data input matches any of the plurality of personal user data, and a second authentication unit that stores a plurality of personal user data that was pre-registered as persons who can receive specified services; and
a communication step that transmits the output signals to the first and second authentication units, and can receive output signals regarding authentication results from the first and second authentication units;
wherein when authentication by the first authentication is successful and the address of the second authentication unit is stored in the service equipment, the second authentication unit will perform authentication by determining whether or not the personal user data input in the input means matches any of the plurality of pre-registered personal user data, and the second authentication unit will permit the use of the service equipment by the user who input the personal user data when the authentication was successful.
